(19) United States
(12) Patent Application Publication
(10) Pub. No.: US 2022/0403982 A1
(43) Pub. Date: Dec. 22, 2022

(54) FILLING STATION FOR GAS CYLINDERS AND MOTOR VEHICLES, AND METHOD

(71) Applicant: CleanTech Swiss AG, Wollerau SZ (CH)

(72) Inventor: Eckhard TILHOF, Altendorf (CH)

(21) Appl. No.: 17/422,036

(22) PCT Filed: Feb. 5, 2020
(86) PCT No.: PCT/EP2020/052804

§ 371 Date: Jul. 9, 2021

(30) Foreign Application Priority Data
Feb. 7, 2019 (EP) 19155865.9

(51) Int. Cl. F17C 5/00; F17C 5/02

(52) U.S. Cl. CPC F17C 5/007; F17C 5/02; F17C 2265/065; F17C 2270/0168; F17C 2201/056; F17C 2205/0107; F17C 2205/013; F17C 2201/0109; F17C 2201/058; F17C 2205/0111; F17C 2205/037; F17C 2221/035; F17C 2223/0153; F17C 2225/0153; F17C 2227/0142; F17C 2250/0421; F17C 2250/0443; F17C 2260/038; F17C 2270/0139

(57) ABSTRACT

A filling station comprises a filling device for an automated filling of a gas bottle inserted in the filling station and a filling device for refueling a motor vehicle, wherein the filling device for an automated filling of a gas bottle inserted in the filling station is arranged adjacent to the filling device for refueling a motor vehicle.

The invention relates to a filling station for liquid gas for being able to fill gas bottles with gas and/or to refuel motor vehicles with gas.

Filling stations tor gas bottles are known from the publications DE 32 14 620 A1, EP 2 169 294 A1 and WO 2013/121067 A1. Publication US 2013/0153084 A1 discloses an automated filling station for gas bottles to be installed in retail stores. Gas filling stations with testing devices are known from the publications FR 2 618 875 A1 and WO 2014/030921 A1. An automated filling station for gas bottles for installation also outside retail stores is known from WO 2016/074924 A1. The filling station known from WO 2016/074924 A1 thus allows a refilling of gas bottles without the need for supervision by professionally trained personnel. This can be arranged within a rack in order to be able to transport such a filling station.

A gas bottle is a pressure vessel for transporting and storing pressurized gases, usually consisting of metal, regularly steel, or fiberglass-reinforced composites or aluminum or a combination of steel and/or aluminum and fiberglass-reinforced composites. Such a bottle may have a volume of more than 100 liters. The nominal pressure can be several hundred bar.

Liquid gas bottles contain gases such as LPG in liquefied form. Common gases are ethane, propane, butane and mixtures thereof. These gases can be liquefied at room temperature by comparatively low pressure.

Liquid gas bottles are closed with a fitting to which a suitable hose line can be screwed, usually in conjunction with a pressure reducer, for the controlled withdrawal of their gaseous contents. Furthermore, liquid gas bottles have a safety valve in the fitting which limits the permissible overpressure in the bottle to approx. 30 bar, for example, in order to prevent bursting.

Typically, a fitting of such a liquid gas bottle has a side connection piece which is used for filling on the one hand and for withdrawal on the other. Lines are manually screwed or pressed onto this side connection piece both in the case of withdrawal and in the case of refilling.

Liquid gas bottles are used, for example, to operate gas stoves, gas cookers, gas grills, gas heaters or gas radiant heaters. Once the contents of a liquid gas bottle have been used up, liquid gas bottles are usually returned by the end user to the point of sate of liquid gas bottles for refilling. After such a return of a liquid gas bottle, it is transported from the point of sale to a central filling plant or filling station.

In order to facilitate refilling, it is known from the publication DE 43 34 182 A1 that a centered filling point can be provided in addition to a side connection piece. Filling can then be carried out from above without the need to align a laterally protruding connection piece. A fitting which enables an automated refilling of gas bottles is also known from publication WO 2016/074923 A1.

A filling station for liquid gas in the sense of the present invention is also a gas station with which motor vehicles can be refueled with liquid gas. Pure gas filling stations are not always staffed. Users then pay by credit card, for example. Supervision by professionally trained personnel is not provided at such filling stations, which are used for refueling motor vehicles.

Refueling gas for motor vehicles is similar to refueling gasoline or diesel. Gas is displayed at the pump in liters (volumetric dispensing). For refueling, i.e. a refilling, a nozzle is firmly connected to a filler neck of the motor vehicle, e.g. screwed together. This results in a closed system between the gas tank of the motor vehicle and the filling station.

From the publication US 6,394,151 B1 discloses a propane gas dispensing system with which propane gas can be dispensed on the one hand to a container for bottled gas and on the other hand to a motor vehicle. The system comprises a scale in a cover. Through the scale, a container for bottled gas can be weighed.

A vending system for gases of a filling station is known from the publication EP 1 246 141 A2. The system comprises a filling station for filling gas bottles. In addition, the system comprises a device for filling gas tanks in vehicles.

It is the task of the invention to provide a further developed filling station.

The task of the invention is solved by a filling station with the features of the main claim and with the features of the additional claims. Advantageous embodiments result from the dependent claims.

A filling station according to the invention basically comprises a filling device for an automated filling of a gas bottle inserted in the filling station and preferably also a filling device for refueling a motor vehicle. The filling device for an automated filling of a gas bottle inserted in the filling station is basically arranged adjacent to the filling device for refueling a motor vehicle. The filling device for an automated filling of a gas bottle inserted in the filling station and the filling device for refueling a motor vehicle preferably form a common front side.

The filling device for an automated filling of a gas bottle inserted in the filling station is arranged adjacent to the filling device for refueling a motor vehicle, if the two filling devices are not separated by a space through which a user of the filling station could walk. In particular, the two filling devices form a common front side that ensures that a user cannot get between the two filling devices. In particular, the front side adjoins an opening of a space in which the two filling devices are located. The space is bordered by walls. At least one wall basically comprises a door so that the space can be entered by technical personnel for repair and maintenance purposes. Thus, in this embodiment, the two filling devices only partially fill the space.

A gas bottle is usually too bulky and too heavy to tie able to transport it to an automated filling station on foot, for example. Therefore, a motor vehicle is usually used to transport a gas bottle to a filling station if a motor vehicle is used, a parking space is required to park the motor vehicle. Such a parking space is also required if the motor vehicle is to be refueled with gas. The parking space must then even be available in the immediate proximity of the filling device that enables the refueling of the motor vehicle. This spatial proximity, which must necessarily be present between a motor vehicle parked on a parking space and the filling device if the motor vehicle is to be refueled, is utilized by the present invention. Since the filling device for an automated filling of a gas bottle inserted in the filling station is adjacent to the filling device for refueling a motor vehicle, the distance between the parked motor vehicle and the filling device for a gas bottle is small. The effort required for refilling a gas battle is therefore small, since only a short distance has to be bridged between the parked vehicle and the filling device for a gas bottle. There is no need to provide a second parking space for a motor vehicle for this purpose. Instead, a parking space is used that must already necessarily be provided for refueling a motor vehicle.

Moreover, in an advantageous embodiment of the invention, the filling station comprises only one tank in which gas for refueling a motor vehicle and gas for refilling the gas bottle is stored. In this embodiment, both filling devices are connected to the tank in a gas-conducting manner, so that both a gas bottle and a motor vehicle can be filled or refueled with gas stored in the tank. This further reduces the effort, since there is no need to have two tanks. This not only saves installation space, but also reduces the maintenance effort and the effort required to fill such a tank.

The filling station is preferably a transportable unit. The filling station is therefore so compact and so stable that it can be lifted by means of a crane, for example, or by means of a lift truck or forklift and loaded onto a transport vehicle for transportation.

The filling station preferably comprises a plurality of assembly units that can be pulled out of the filling station separately from one another. One assembly unit is the filling station configured for the automated filling of a gas bottle inserted into the filling station. One assembly unit may be a filling device for refueling a motor vehicle. The filling station can thus be variably adapted to a requirement. An assembly unit that is not needed can be removed, for example the filling device for refueling a motor vehicle. The filling station can then only be used for filling a gas bottle. If the requirement changes, a filling device for refueling a motor vehicle can be inserted. Subsequently, it is also possible to refuel a motor vehicle.

In particular, the filling station comprises a payment device to enable payment for the amount of gas received. By payment device is meant a device that enables payment without the need for an additional supervisor such as a cashier. In particular, the payment device enables cashless payment, for example by means of a credit card, a debit card, a customer card or a mobile phone. However, the payment device can also enable payment by means of cash as an alternative or supplement. In this embodiment, the filling station therefore does not require personnel to receive and pay for gas.

In one advantageous embodiment, the filling station comprises a walkable platform in front of the one or two filling devices. The walkable platform ensures that a motor vehicle cannot be parked in such a way that a user cannot reach the filling device for an automated filling of a gas bottle inserted in the filling station, for example. The walkable platform therefore reliably prevents a car from parking in front of it. Since the platform is walkable, it is wide enough for a normal-sized adult man to walk onto it unhindered, even if a motor vehicle is parked immediately adjacent to the platform. Thus, this walkable platform differs from elevations that are usually present around a filling device of a gas station. Such elevations are only intended to prevent a motor vehicle from reaching a filling device. These elevations are therefore basically constructed so narrow that they are not wide enough for easy walking. Thus, if a motor vehicle is parked immediately adjacent to such an elevation, the elevation cannot be easily walked onto by a normal sized adult male. Also, such elevations are basically located on all sides of a filling device of a gas station. In contrast, the walkable platform is basically only located on one side of the filling station in order to keep the installation area of the filling station as small as possible.

In one embodiment, the walkable platform is at least 60 cm, preferably at least 80 cm, wide. This ensures a distance between the two filling devices and the motor vehicle of at least 60 cm or 80 cm. This distance is sufficient for a normal-sized adult man to easily reach the filling device for the gas bottle with a gas bottle. To avoid having to provide an excessively large installation area for the filling station, the walkable platform is preferably no more than 150 cm, particularly preferably no more than 120 cm, wide.

The walkable platform can be semicircular or triangular, for example. The walkable platform is preferably rectangular. Thus, it is basically a rectangular plate, which is preferably at least 60 cm wide and/or preferably not wider than 150 cm. The length of the rectangular plate basically exceeds the width to be able to see or reach elements present on the front side of the filling station, in one embodiment of the invention, the walkable platform is at least 100 cm, particularly preferably at least 120 cm or preferably at least 150 cm long. So that the installation area for the filling station does not become too large and the filling station can be easily transported, the walkable platform is no more than 300 cm, particularly preferably not more than 250 cm, long. The front side of the filling station is the side at which the one or two filling devices are located. Besides to the one or two filling devices, there are basically one or more screens for displaying, for example, a filled quantity of gas or instructions for operating the filling station. The front side also preferably has a payment device to be able to pay for the amount of gas received. If the rectangular plate is 60 cm wide, this ensures that there is a distance of at least 60 cm between a parked vehicle and the front side.

To ensure, in an improved manner, that a motor vehicle does not accidentally drive onto the walkable platform, there are one or more beams protruding upwards from the platform, namely preferably vertically. The one or more beams are located at the outer edge of the platform. In particular, two beams are provided at the exterior corners of the walkable platform. The outer edge or the exterior corners of the walkable platform mean the edge or the corners that have a distance to the aforementioned front side.

For stability reasons, two beams are preferably part of a rectangular or square frame. The frame preferably consists entirely of steel. Also, the lower horizontally extending beam of the frame in the installed state of the filling station ensures in a further improved manner that a motor vehicle cannot accidentally drive onto the walkable platform. Advantageously, the walkable platform is then located on or above the aforementioned lower horizontally extending beam of the frame.

Preferably, the filling station has a cage formed of beams to protect the filling station during transport, among other things. The aforementioned frame is then part of the cage. The one or two filling stations are arranged inside the cage.

The one or more beams preferably consist of hollow sections with a rectangular or square cross-section so that suitably stable beams with low weight can be provided. The one or more beams preferably consist of steel for stability reasons.

In one embodiment, a lower horizontally extending beam in the installed state of the filling station has two openings for a fork of a forklift or a lift truck. The lower horizontally extending beam is in particular part of a frame or a cage formed by beams. The fork of a forklift or lift truck can be pushed through the openings so that the filling station can finally be lifted and transported by means of the forklift or lift truck.

The walkable platform is preferably arranged on or above the lower horizontally extending beam. The walkable platform is then raised in a stepped manner above the surface on which the filling station is placed. This prevents a motor vehicle from accidentally driving onto the walkable platform in an improved manner. A desired distance between a motor vehicle parked in front of the filling station and the filling devices is thus kept particularly reliably. A user can reach all operating elements and filling devices at all times.

The walkable platform can be formed by a steel plate, for example, A steel plate is sufficiently stable to withstand the mechanical loads permanently and reliably. However, the walkable platform can also be provided by a plate made of wood.

Preferably the walkable platform is covered to protect a user from rain.

A filling station for gas, which comprises at least one filling device, for example for an automated filling of a gas bottle inserted in the filling station, preferably comprises a plurality of assembly units which can be pulled out of the filling station separately from one another. Maintenance of this filling station can be performed particularly quickly. If an assembly unit is defective, it can first be replaced so that the filling station can be used again as quickly as possible. It is also possible to equip a filling station with freely selectable components. In this way, a filling station with a filling device for an automated filling of an inserted gas bottle can be provided, which is also configured such that it can be retrofitted with a filling device for refueling a motor vehicle by adding a corresponding assembly unit by insertion. Such a filling station thus has a corresponding free space, or else a corresponding free space can be created, for example by removing a wall, in order to be able to add a further assembly unit subsequently.

Each assembly unit preferably comprises rollers which allow each assembly unit to be rolled out of the filling station. The effort required for assembly and replacement is thus kept particularly low.

The one or more assembly units can preferably be pulled out of a space with a lockable door. This helps to protect the assembly units from unauthorized access.

Preferably, the assembly units can be pulled out in the direction from which the one or more filling devices can be operated by a user. A particularly simple and compact construction of the filling device is thus possible.

The assembly units can preferably be connected to each other, for example, by one or more bars on one side. A bar can be non-destructively detached from at least one assembly unit. A bar can be non-detachably connected to an assembly unit. The bar is then arranged such that it can be detachably connected to a further assembly unit and/or a frame part of the filling station. However, it is preferably possible for the bar not to be non-detachably connected to said assembly unit, i.e. to be detachable non-destructively by means of tools, for example. Instead of a bar, another connecting means can also be provided by which two assembly units can be connected to each other and/or an assembly unit can be connected to a frame part of the filling station. This other connecting means is then also designed in such a way that it can be detached from at least one assembly unit, preferably from two assembly units, in order to be able to subsequently replace an assembly unit. This helps to protect the assembly units from unauthorized access.

The detachable connection of a bar or another connecting means to an assembly unit or a frame part is done, for example, with one or more screws and/or a bayonet connection and/or a snap-in connection.

A connecting means such as a bar is preferably arranged on the back side of assembly units in order to be able to protect such connecting means from unauthorized access. Operating elements for filling with gas are then present on the side and/or on the front side of the assembly units. The back side is then located in particular within a lockable space in order to be protected against unauthorized access.

One assembly unit is preferably the filling device for an automated filling of a gas bottle inserted in the filling station. One assembly unit is preferably the filling device for refueling with gas. One assembly unit preferably comprises an operating and/or payment device. This subdivision makes it possible to flexibly assemble a filling station. In this way, a filling station can be assembled which, in addition to an operating and/or payment device, comprises a filling device for an automated filling of a gas bottle inserted in the filling station and/or a filling device for refueling with gas. If, for example, an operator has initially purchased a filling station that comprises, in addition to an operating and/or payment device, a filling device for an automated filling of a gas bottle inserted in the filling station, he can add a filling device for refueling motor vehicles with gas at a later stage.

The assembly units are in particular part of a closed front side. Gas can be drawn from this front side by a user. Otherwise, the assembly units can be shielded in such a way that they are protected from unauthorized access. This is achieved in particular by accommodating the assembly units in a space which can be entered from a back side through a preferably lockable door. This space comprises an opening at the front through which the assembly units can be added or removed.

An assembly unit may comprise one or more lockable flaps on its front side. This makes it possible to perform maintenance work from the front side by authorized persons. On the one hand, in an advantageous embodiment, the aforementioned space can be entered through a lockable door in order to perform maintenance work from the space, for example. On the other hand, maintenance work can be performed by authorized persons by opening a first lockable flap. Authorized persons can also perform maintenance work by opening a second lockable flap. This makes it possible to provide for different authorized persons. For example, one authorized group of persons can only open a first flap in order to replace printer paper, for example. Another group of authorized persons can open a second flap, for example to carry out electrical maintenance work. The next group of authorized persons can open the door, for example, to replace assembly units.

The filling device for refueling a motor vehicle basically comprises a nozzle adapted to be firmly connected to a filler neck of a motor vehicle.

The filling station according to the claims basically enables an automated refilling of a gas bottle by an end user and also preferably a refueling of a motor vehicle with gas. The gas provided is in particular a liquid gas, i.e. a gas which is liquefied at room temperature by compression. The gas provided is in particular LPG, which is also called autogas.

The filling device for an automated filling of a gas bottle inserted in the filling station basically comprises an insertion device that enables an end user to insert an emptied gas bottle into the filling device. The insertion device may comprise a retainer on which the emptied gas bottle can be placed. The insertion device may comprise a housing with an opening. An emptied gas bottle can then be brought through the opening into the interior of the housing to be placed within the housing. The housing then comprises air impermeable walls. The insertion device may comprise a cage having an opening. An emptied gas bottle can then be brought through the opening into the interior of the cage to be placed within the cage. The boundaries of the cage are formed by grids.

The filling device for an automated filling of a gas bottle inserted in the filling station basically comprises a locking device for locking after the gas bottle has been inserted in such a manner that a removal of the gas bottle is not possible after it has been locked. The end user cannot remove the gas bottle in the locked state. A gas bottle can be inserted into the aforementioned housing or the aforementioned cage in this way. The locking device may then comprise a door, flap or shutter with which the opening of the housing or cage can be closed in such a way that an end user cannot open the door, flap or shutter, respectively. Alternatively or additionally, the locking device may include grippers that enclose a bottle, inserted into the filling device after an emptied gas bottle has been inserted into the filling device. Once an inserted gas bottle has been enclosed by the grippers, an end user can no longer remove the inserted gas bottle.

The filling device for an automated filling of a gas bottle inserted in the filling station basically comprises a refilling device for an automated filling of an inserted emptied gas bottle after the locking. Filling can therefore only take place if the filling device is appropriately locked by the locking device and the gas bottle cannot therefore be removed. The filling device for an automated filling of a gas bottle inserted in the filling station basically comprises a gas testing device for an automated gas leakage test after refilling an inserted gas bottle. This is used to check the tightness of a refilled gas bottle. The filling device for an automated filling of a gas bottle inserted in the filling station basically comprises a release device that releases a previously filled gas bottle only after a successful gas leakage test, thus enabling a refilled gas bottle to be removed. A removal of a gas bottle filled with gas or liquid gas by an end user is therefore only possible if the gas leakage test has shown that no gas escapes from the filled bottle. The filling device for an automated filling of a gas bottle inserted in the filling station basically comprises an opening mechanism by which a valve of the gas bottle can be opened for a refilling in an automated manner, i.e. without human intervention.

The filling device for an automated filling of a gas bottle inserted into the filling station is thus configured in such a way that an end user can refill a gas bottle used by him with gas for further use without having to dispense a gas bottle at a responsible dispensing point such as a point of sale. This eliminates the need for the usual onward transport from a dispensing point to a central filling plant. This reduces transport costs and the associated personnel expenses. An end user can receive a refilled bottle back regardless of loading opening times.

Since an end user will only receive a filled bottle back if it is actually gas-tight, there is no risk that a defect in a gas bottle will go unnoticed and thus increased safety risks for an end user exist.

In one embodiment, a gas leakage test is also performed controlled by a control device before refilling. If this gas leakage test shows that an inserted, largely emptied gas bottle is already leaking, it is not refilled. Preferably, the remaining contents are emptied instead and, in particular, the completely empty bottle is released to the end user.

In one embodiment, a gas leakage test is performed controlled by a control device during refilling. If it is determined during the refilling that gas escapes from the gas bottle, the refilling is stopped in a manner controlled by the control device. The inserted gas bottle is then released by the release device. A user is prompted acoustically and/or visually via an output device comprising a loudspeaker and/or a display to check the state of the gas bottle and/or to close the gas tap of the bottle in order to subsequently reinsert the bottle. If, controlled by the control device, it is determined after reinsertion of the gas bottle into the filling station that the gas bottle is nevertheless not tight, the gas bottle is not refilled. Preferably, the remaining contents are emptied instead and, in particular, the completely emptied bottle is released to the end user.

In one embodiment, the filling device for an automated filling of a gas bottle inserted in the filling station comprises an identification device with which a gas bottle can be identified. It can thus be determined whether a gas bottle is suitable for an automatic filling. By means of a corresponding controlling device, filling can be controlled based on the result of an identification. Filling is therefore only carried out if it has been previously determined by the identification device that the inserted gas bottle is suitable. Through the identification also the volume and size of the inserted gas bottle can be determined. This allows the refilling process to be controlled and accelerated. Deviations from the expected result, for example with regard to the filling volume, can be used to identify malfunctions. For example, it is determined by the identification device that a maximum of 5 kg of gas may be filled into an inserted gas bottle. By measuring the weight of the inserted gas bottle that has not at been refilled, the filling station determines that there is still a residual gas quantity of 1 kg in the gas bottle. The filling device for an automated filling of a gas bottle inserted in the filling station can then be configured such that it is determined in an automated manner, before the filling process begins, that no more than 4 kg is filled into the gas bottle.

To reduce problems due to misuse and vandalism, the filling device for an automated filling of a gas bottle inserted in the filling station is configured such that it is principally locked. In the locked state, no gas bottle can be inserted into the filling station and no gas bottle can be removed from the filling station either. If a gas bottle is to be inserted, it must first be identified as suitable by the identification device.

In one embodiment, the inserted gas bottle is alternatively or additionally identified by the identification device, preferably after locking of the filling device for an automated filling of a gas bottle inserted in the filling station. In this way, a final check is made to ensure that a suitable gas bottle has actually been inserted, in order to avoid malfunctions in a further improved manner.

Preferably, in the inserted state, the gas bottle is in a completely closed space when the filling device for an automated filling of a gas bottle inserted in the filling station is closed, in order to shield an inserted gas bottle from the outside in the maximum possible manner when it is filled again. Safety is thus further improved.

In one embodiment, the filling device for an automated filling of a gas bottle inserted in the filling station comprises a scale by means of which the weight of an inserted gas bottle before refilling and/or after refilling is determined. By determining the weight of the gas bottle before refilling, the filling station can determine how much gas can be filled into the bottle. By determining the weight of the gas bottle after refilling, the filling station can check whether the gas bottle has been completely and properly filled. Deviations from the expected result signal a malfunction and thus contribute in an improved manner to safety. By determining the weight of the gas bottle both before refilling and after refilling, it is possible to determine how much gas has been filled into the bottle. This can be used to control the filling and/or to bill the end user. Alternatively or additionally, a gas flow meter in a supply line of the filling station can be used to determine how much gas has been filled into an inserted gas bottle, for example to bill the end user or to determine malfunctions. Partially filled gas bottles can then also be filled completely. An end user can therefore refill his gas bottle completely ahead of time in order to reliably have gas available at all times.

Preferably, a gas flow meter is used to determine how much gas has been filled into an inserted gas bottle. An optionally provided is then preferably used exclusively for safety-related checking of the degree of filling of the bottle. In one embodiment, it is checked by means of a controlling device whether the increase in weight determined by the scale corresponds to the gas volume that has been measured by the gas flow meter. In the event of an excessively high deviation, a malfunction is thus determined and signaled, for example, acoustically and/or optically. A gas bottle that is then used can then be returned to the user completely empty, for example, and/or technical personnel can be informed of the malfunction in an automated manner, for example, for the purpose of rectifying the malfunction. If an additionally performed leak test shows that the gas bottle is tight, technical personnel may be informed in an automated manner that the filling station may be faulty and/or the filling station may be taken out of service in an automated manner.

In one embodiment of the invention, the filling device for an automated filling of a gas bottle inserted in the filling station comprises an emptying device with which an inserted gas bottle can be emptied. The emptying device empties the contents of an inserted gas bottle, in particular, when a malfunction has been detected. If, for example, a gas tightness test shows that the filled gas bottle is not tight, the gas bottle is emptied by the emptying device. Risks are thus further reduced in an improved manner.

The filling station is preferably configured such that it automatically determines whether the assembly unit gas bottle with bottle valve and/or fitting is holding pressure and/or is gas-tight. Whether the pressure in a gas bottle is maintained is determined by means of one or more pressure sensors. One or more gas detection sensors are used to determine whether gas is leaking from the gas bottle into the environment. For safety reasons, both one or more pressure sensors and one or more gas detection sensors are preferably present in order to automatically detect gas tightness problems.

In one embodiment of the invention, the filling station is such that it can already be connected to an existing gas tank. This embodiment is particularly suitable for installation at gas stations.

In one embodiment of the invention, the filling station comprises an own gas tank. This embodiment is suitable for installation in campgrounds and the like.

In one embodiment, the filling station has the dimensions of a standard size container, preferably a 10-foot container, 20-foot container, or 40-foot container. The transport of a filling station is thus facilitated.

In one embodiment, the filling station has quick-release fasteners for fastening the filling station by means of the quick-release fasteners, for example on a semitrailer. This further facilitates transport in an improved manner.

In one embodiment, the filling station, preferably including an own gas tank, is part of a semitrailer, a trailer or part of a truck, thus creating a mobile filling station. In this way, it is possible to react quickly to the respective demand, for example depending on the seasons, in order to set up filling stations at desired locations, such as campsites, only for a limited period of time.

In one embodiment of the invention, the filling station comprises a payment device via which payment for refilling can be made, for example by means of a debit card, credit card, in cash, by means of a mobile telephone, and/or in another electronic way.

In one embodiment of the invention, the filling station comprises a piston pump with which gas is conveyed. The piston pump comprises at least one piston that can be moved up and down in a cylinder. At one end of the cylinder, there is an inlet equipped with an inlet valve into the cylinder and an outlet equipped with an outlet valve out of the cylinder. A piston pump is preferred because it can be used to suitably convey gas in both liquid and gaseous states. The piston comprises one or more sealing rings to enable a gas-tight connection to be made between the piston and an inner wall of the cylinder. When the piston is moved toward the outlet, gas that is in the cylinder is thereby pumped out of the outlet. If the piston is moved away from the inlet, gas is drawn in through the inlet.

The piston of the piston pump is in particular driven by means of an electric motor so that gas can be reliably conveyed even at extreme temperatures without having to expend an excessive of effort. In order to be able to move the piston, it is fastened to a piston rod. The piston rod is preferably in two parts and has a joint. The joint makes it possible for the part of the piston rod that is connected to the piston not to perform any pivoting movements. This part of the piston rod that does not perform any pivoting movements is sealed by a sealing element preferably in such a way that the sealing element prevents gas from escaping from the cylinder into the space in which the part of the piston rod that performs swivel movements during operation of the piston pump is located. This is a particularly reliable way of preventing gas from escaping unintentionally, which can be problematic in particular in the case of an electric motor because of the risk of explosion. Preferably, the part of the piston rod that does not perform any swiveling movements is guided by a guide. This ensures particularly reliably that this part of the piston does not perform any pivoting movements.

Preferably, there is only one piston pump with which gas is extracted from a gas bottle and gas is pumped out of a tank in order to be able to fill a gas bottle or to refuel a motor vehicle. In order to be able to make do with only one piston pump, there is preferably a device equipped with control valves with which gas flows can be suitably directed. This device thus achieves that either gas is pumped out of a gas bottle or gas is taken from a tank.

Preferably, the piston pump comprises two or four pistons for a pumping or sucking gas, which are each located in cylinders and which are preferably driven by an electric motor. Cylinders are connected to each other via a pressure relief valve in such a way that, if an excessively high overpressure occurs in one cylinder, gas can be conveyed from this cylinder to another cylinder. The occurrence of an excessively high overpressure is thus avoided particularly reliably. Nevertheless, no gas escapes into the environment. In particular in this embodiment, one piston is located at a lower end of its cylinder and thus remote from the inlet and outlet, when another piston is located at an upper end of its cylinder and thus close to the inlet and outlet of the piston pump.

In one embodiment, the filling station comprises a filling device for refueling a motor vehicle, which is configured such that a motor vehicle can be refueled with a liquid fuel such as diesel or gasoline using this filling device. The filling device then comprises a corresponding nozzle, such as is present at gas stations, in order to be able to refuel a vehicle with a liquid fuel.

In one embodiment, the filling station comprises more than one filling device for refueling a motor vehicle. A first filling station may be provided for refueling a tank of a motor vehicle with a gaseous fuel and a second filling device may be provided for refueling a motor vehicle with a liquid fuel.

The figures show:

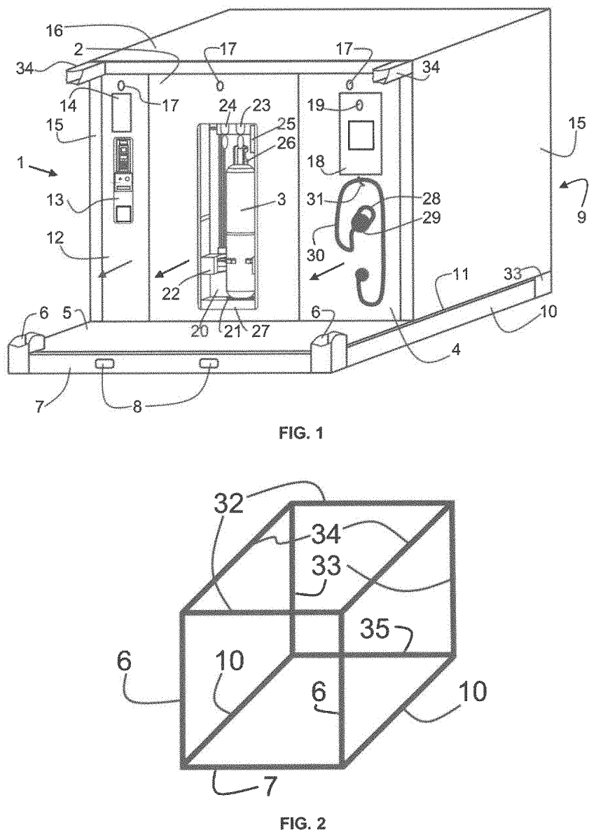

FIG. 1: Filling station with numbering machine;

FIG. 2: Cage of the filling station;

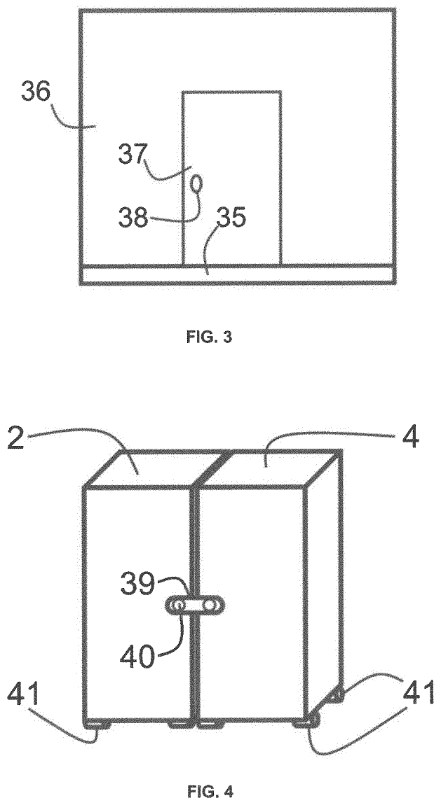

FIG. 3: Back side of the filling station;

FIG. 4: Assembly units of the filling station;

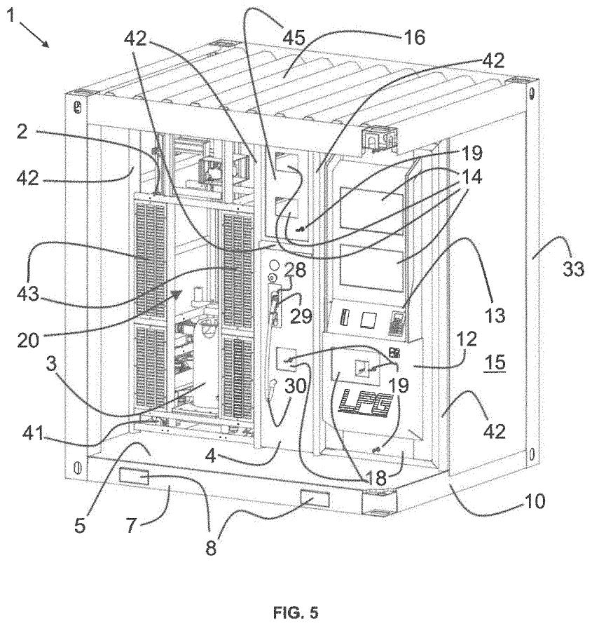

FIG. 5: Front side of another filling station;

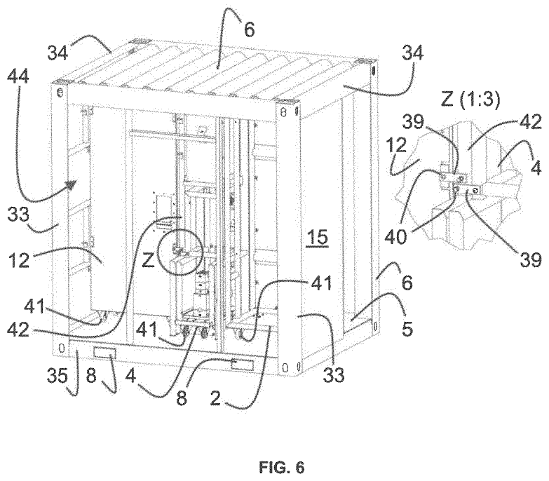

FIG. 6: Interior space as seen from the back side.

FIG. 1 shows a filling station 1 comprising a filling device 2 for an automated filling of a gas bottle 3 inserted in the filling station, and a filling device 4 for refueling a motor vehicle. The filling device 2 for an automated filling of a gas bottle 3 inserted in the filling station 1 is arranged adjacent to the filling device 4 for refueling a motor vehicle. In front of the two filling devices 3 and 4 there is a walkable platform 5, which is provided by a date consisting of steel. The walkable platform 5 is 80 cm to 140 cm wide and 150 cm to 250 cm long.

Two only partially shown beams 6 protrude vertically upwards from the platform. The two beams 6 are located at the outer edge of the platform 5, namely the two corners of the outer edge. The two beams 6 are part of a frame formed from beams. In FIG. 1, there is also shown the lower horizontally extending beam 7 of the frame. This has two continuous openings 8 for a fork of a forklift.

On the back side 9 there is an identically built frame. The corners of the two frames are connected by a total of four longitudinal beams 10. In total, a cage consisting of beams is provided which protects the filling station. All beams 6, 7, 10 consist of steel and have a square or rectangular hollow cross section. The ends of the beams 6, 7, 10 are welded and/or bolted together and connected in this way. The walkable platform 5 is located above the lower horizontally extending beam 7 and rests on it. In addition, the walkable platform 5 rests on the lateral lower longitudinal beams 10. The platform 5 is fastened to these beams 7 and 10, for example by a screw connection or a riveted connection.

The two filling devices 2 and 4 are assembly units which can be pulled out separately from each other towards the front as indicated by arrows and in the direction from which the filling devices 2 and 4 can be reached by a user. To facilitate this, the filling devices 2 and 4 have rollers on the underside and stand on a base 11 which forms a common flat surface with the walkable platform 5. In order to provide the base 11 and the walkable platform 5, a common plate, for example consisting of steel, can be provided. However, there may also be a plurality of plates which are assembled accordingly. The substrate 11 also rests on the lower beams 10 accordingly and is fastened to them, for example screwed or riveted. There is a further assembly unit 12 which is rollably supported by rollers and can be pulled out towards the front, and which comprises an operating and payment device 13 and one or more displays 14. The assembly unit 12 is also located on the base 11.

All assembly units 2, 4 and 12 are located in a walkable space which comprises two side walls 15 and a ceiling 16. The walkable space is bounded at the bottom by the base 11. The walkable space further comprises a back wall on the back side 9, which is equipped with a lockable door. All assembly units 2, 4, 12 which can be rolled out of the walkable space towards the front are less deep than the walkable space. The walkable space can therefore be accessed via the back side through the door provided here. Assembly work on the back side of the assembly units is thus possible. In addition, the back sides of the roll-out assembly units 2, 4, 12 are protected against unauthorized access when the door is locked.

The roll-out assembly units 2, 4, 12 are connected to each other at their back sides by bars. The bars can be non-destructively detached from the assembly units by means of tools.

The roll-out assembly units 2, 4, 12 have closed front sides, which can have locks 17. The locks 17 can be locked by means of keys, for example. The locks 17 can be used for locking. An assembly unit 2, 4, 12 can then only be pulled out to the front once the associated lock 17 has been unlocked. This protects the filling station in a further improved manner against unauthorized incorrect operation.

Each assembly unit may comprise one or more lockable flaps 18 on its front side, for example to enable printing paper to be exchanged. Also such flaps 18 basically comprise locks 19 with which a respective flap 18 can be locked. Corresponding keys are then required to be able to open a flap 18. This also serves to protect against unauthorized access.

The filling device 2, which is provided for filling an inserted gas bottle 3, has an interior space 20 for inserting a gas bottle 3. A gas bottle 3 with a maximum permissible filling quantity of 35 kg is shown. The interior space 20 can be completely closed by a door not shown, for example a sliding door or a shutter, and preferably in a gas-tight manner. The sliding door or the shutter are preferably opened and closed automatically and controlled by a control device. In the interior space 20 there is a retainer 21 on which the gas bottle 3 can be placed. There is a centering device 22 with gripper arms with which the gas bottle 3 can be centered. A movable filling head 23 is located in the interior space 2, via which the gas bottle 3 can be filled with gas. Next to the filling head 23 is a movable suction head 24, via which an inserted gas bottle 3 can be emptied. The interior 20 further contains a movable leak test head 25 of a gas testing device, which can be used to check whether the gas bottle 3 is gas-tight.

In the case of FIG. 1, the filling head 23 is connected to the gas bottle 3 for filling. The gas bottle 3 has a filling with a centered filling point 26, so that the gas bottle 3 can be filled and emptied from above.

The possibility of movement serves to connect the filling head 23, the suction head 24 and the leak test head 25, the fitting of the gas bottle 3 as required. The movement of the filling head 23, the suction head 24 and the leakage test head 25 is carried out in an automated manner by a motor drive not shown together with a control device not shown.

The retainer 21 is placed on a scale 27 in order to be able to determine the total weight of an inserted gas bottle 3.

A gas detection sensor is located in the leak test head 25. When the leak test head 25 is placed on the gas bottle 3 from above as intended, the leak test head 25 provides an interior space in which the fitting of the gas bottle with the centered filling point 26 is located. In this way, it can be determined particularly quickly and reliably by the gas detection sensor whether the fitting or the connection between the fitting and the gas bottle 3 is leaking.

The filling device 4 provided for refueling a motor vehicle, comprises on the front side a nozzle 29 which can be stored in a storing 28. The nozzle 29 can be removed from the storing 28 in order to refuel a motor vehicle. The nozzle is connected to a hose 30 through which gas is passed during refueling. In addition, a suspension 31 for the hose can be provided on the front side.

An external tank for gas may be provided. Both filling devices 2 and 4 are then connected to the tank in a gas-conducting manner, so that both a gas bottle 3 and a motor vehicle can be filled or refueled with gas stored in the tank. The external tank may be located underground. The filling station 1 then includes coupling devices, for example on the back side or on the side, in order to be able to connect the tank to the filling station 1 accordingly.

The filling station 1 comprises such a small footprint that it can easily be transported by a truck. The footprint corresponds to the size of a passenger car, for example, so that a standard parking space for a passenger car is sufficient to install the filling station 1.

The sequence of assembly units 2, 4 and 12 can also be different. For example, assembly unit 12 can also be located between assembly units 2 and 4. Assembly unit 4 can be provided between assembly units 2 and 12.

FIG. 2 shows the cage for filling station 1 formed by steel beams 6, 7, 10, 32 to 35. Steel beams 6, 7 together with the front steel beam 32 form a frame. Beams 33 and 34 can also be seen suggestively in FIG. 1.

FIG. 3 shows the rear wall 36 of the filling station with a door 37 that can be locked with a lock 39. Behind the door 37 is the walkable space.

FIG. 4 shows as an example two assembly units 2 and 4 that are connected to each other by a bar 39 on the back side. The bar 39 can be screwed to the back side of the assembly units 2 and 4 by means of screws 40. The bar 39 can therefore be loosened again by means of a screwdriver, i.e. by means of a tool. Alternatively or additionally, the bar 39 can be suspended, for example, in hooks which are present on the back side of the assembly units 2 and 4. Each bar 39 can also be positively connected to the back side of the assembly units 2 and 4 in another way. With the aid of such bars 39, assembly units 2, 4 or 12 can also be detachably fastened to walls of the interior space, for example by means of screws or by means of positive connections.

Rollers 41 are provided on the undersides of the assembly units 2, 4 in order to be able to roll the assembly units 2, 4 into or out of the aforementioned walkable space of the filling station 1.

The filling station 1 is equipped with an emergency power supply, a mobile phone connection and/or an alarm system, as is present with cars.

FIG. 5 shows a front side with a further configuration of a filling station. The filling station differs from the filling station shown in FIG. 1 primarily in the provision of an inner frame 42. The inner frame is immovably mounted and is provided as a permanent component of the filling station. The inner frame 42 is such that the assembly units 2, 4, 12 can be fastened to the inner frame 42 by means of bars.

Two sliding doors 43 are present which can be opened and closed by motor. The two sliding doors 43 allow the interior space 20, which is provided for inserting a gas bottle 3, to be opened and closed in an automated manner.

The configuration shown in FIG. 5 comprises a removable module 45 that comprises a computer and one or two displays. Preferably, module 45 can be pulled out in the forward direction like modules 2, 4, 12, to remove module 45. It is preferably fastened in the same manner as modules 2, 4, 12. Thus, it can be detached from the walkable space to subsequently remove the module 45. Since a module with a computer can be comparatively small and light, it is preferably arranged above another module, for example as shown in FIG. 5 above the module 4, i.e. above the filling device 4. By means of the computer of the module 45 the filling device is controlled. The module 45 preferably comprises one or two displays 14. Via such a display 14, which may be a touch-sensitive display, a filling of a gas bottle and/or a refueling of a motor vehicle are controlled in one embodiment by a user of the filling station. Another display 14 can he used for advertising, for example.

FIG. 6 shows a view into the walkable space 44. Thus, the representation of the door 37 and the back wall 36 is missing. To the right of this is an enlarged view Z, which shows that the assembly units are fastened to the inner frame 42 on their back sides by means of bars 39. The lower horizontally extending beam 35 also has two through openings 8 for a fork of a forklift. Therefore, the filling station can also be lifted and transported from the back side by means of a forklift.

In one embodiment, a measurement module that is not shown is arranged in the walkable space. The measuring module is used to measure the amount of gas dispensed by refueling a motor vehicle or by filling a gas bottle. This is preferably done by measuring the dispensed gas volume, for example by means of a Coriolis mass flow meter. If a gas bottle is filled, the measured gas volume is preferably converted into a weight unit such as kg in order to be able to specify the quantity of gas obtained in a weight unit, for example in kg.

1. Filling station comprising a filling device for an automated filling of a gas bottle inserted in the filling station and a filling device for refueling a motor vehicle, wherein the filling device for an automated filling of a gas bottle inserted in the filling station is arranged adjacent to the filling device for refueling a motor vehicle.

2. Filling station according to claim 1, wherein the filling station comprises a plurality of assembly units which can be pulled out of the filling station separately from one another, and one assembly unit is the filling station configured for the automated filling of a gas bottle inserted in the filling station.

3. Filling station according to claim 2, wherein an assembly unit is a filling device for refueling a motor vehicle.

4. Filling station according to claim 1, wherein the filling device for an automated filling of a gas bottle inserted in the filling station comprises an insertion device into which a gas bottle can be inserted, that the filling device for an automated filling of a gas bottle inserted in the filling station comprises a locking device for a locking after the insertion of the gas bottle into the insertion device in such a manner that a removal of the gas bottle after the locking is not possible, and that the filling device for an automated filling of a gas bottle inserted in the filling station comprises a refilling device for an automated filling of an inserted emptied gas bottle after the locking.

5. Filling station according to claim 1, wherein a tank for gas is provided and both filling devices are connected to the tank in a gas-conducting manner, so that both a gas bottle and a motor vehicle can be filled or refueled with gas stored in the tank.

6. Filling station according to claim 1, wherein it comprises a walkable platform in front of the two filling devices, wherein the walkable platform is at least 60 cm, preferably at least 80 cm, wide and/or wherein the walkable platform is not more than 150 cm, preferably not more than 120 cm, wide and/or wherein the walkable platform is at least 100 cm, particularly preferably at least 120 cm, long and/or wherein the walkable platform is not more than 300 cm, particularly preferably not more than 250 cm, long.

7. Filling station according to claim 1, wherein one or more beams protrude upwards from the walkable platform and the one or more beams are arranged at the outer edge of the walkable platform, namely at the two corners of the outer edge.

8. Filling station according to claim 7, wherein the beams are part of a frame formed of beams, wherein the lower horizontally extending beam of the frame has two openings for a fork of a forklift.

9. Filling station according to claim 1, wherein the walkable platform is arranged on or above the lower horizontally extending beam of the frame.

10. Filling station, according to claim 1, wherein the filling station comprises a plurality of assembly units which can be pulled out of the filling station separately from one another.

11. Filling station according to claim 10, wherein each assembly unit comprises rollers which allow each assembly unit to be rolled out of the filling station.

12. Filling station according to claim 10, wherein the assembly units can be pulled out of a walkable space with a lockable door.

13. Filling station according to claim 10, wherein the assembly units can be pulled out in the direction from which the filling devices are operable by a user.

14. Filling station according to claim 10, wherein the assembly units are connected to each other by bars on one side and/or that the assembly units are fastened to an inner frame by means of bars and the bars can be non-destructively detached from the assembly units and/or the inner frame.

15. Filling station according to claim 14, wherein the bars are arranged at the back side of the assembly units and operating elements for filling with gas are present at the front side of the assembly units.

16. Filling station according to claim 10, wherein one assembly unit is the filling device for an automated filling of a gas bottle inserted in the filling station and/or one assembly unit is the filling device for a refueling with gas and/or one assembly unit comprises an operating and/or payment device.

17. Filling station according to claim 10, wherein one or more, preferably all assembly units comprise closed front sides.

18. Filling station according to claim 10, wherein an assembly unit comprises a lockable flap on the front side.

19. Method for an automated filling of a gas bottle comprising the steps:
an end user inserts the gas bottle into a filling device provided therefor;
a locking device of the filling device locks in such a way that the inserted gas bottle can no longer be removed by the end user after the locking;
after the locking, the inserted gas bottle is filled with gas in an automated manner, after the automated filling with gas, the locking device opens, after the locking device has opened, the end user removes the gas bottle filled with gas.

20. Method according claim 19, wherein the end user, who has inserted the gas bottle into the filling device provided therefor, refuels a motor vehicle by means of a filling device of the filling station configured for refueling a motor vehicle.
